(19) United States
(12) Patent Application Publication
(10) Pub. No.: US 2025/0075435 A1
(43) Pub. Date: Mar. 6, 2025

(54) MOISTURE MANAGEMENT OF PAPERBOARD STRUCTURES

(71) Applicant: Sonoco Development, Inc, Hartsville, SC (US)

(72) Inventors: Ismael A. Hernández Rosario, Florence, SC (US); Ty Harvey, Florence, SC (US)

(73) Assignee: Sonoco Development, Inc., Hartsville, SC (US)

(21) Appl. No.: 18/816,711

(22) Filed: Aug. 27, 2024

Related U.S. Application Data
(60) Provisional application No. 63/535,861, filed on Aug. 31, 2023.

(51) Int. Cl. D21H 27/36; B31F 5/04; C09J 105/02; C09J 131/04; C09J 133/02; C09J 133/12; C09J 133/26; D21H 19/12; D21H 21/16

(52) U.S. Cl. CPC D21H 27/36; B31F 5/04; C09J 105/02; C09J 131/04; C09J 133/02; C09J 133/12; C09J 133/26; D21H 19/12; D21H 21/16

(57) ABSTRACT

A moisture control mechanism that allows a desired amount of moisture to evaporate out of a multiple ply paperboard structure is provided. The moisture control mechanism comprises an adhesive that adheres the multiple plies together, the adhesive comprising dextrin and an acrylic polymer. Alternately or additionally, a strength preservation mechanism that allows a strength to be maintained even when a multiple ply paperboard structure is highly wet. The strength preservation mechanism comprises an adhesive that adheres multiple plies together, the adhesive comprising dextrin and an acrylic polymer.

### BACKGROUND OF THE INVENTION

### Field of the Invention

This disclosure relates to moisture management of paperboard structures, such as paperboard tubes for carrying textiles. More particularly, this disclosure relates to a moisture control mechanism that allows moisture to leave the paperboard tube until the moisture level of the tube equals a predetermined value or is within a predetermined range. Once this threshold is achieved, the moisture barrier becomes active and limits the moisture penetration into or out of the paperboard tube.

Another aspect of this disclosure is related to preserving the strength of the paperboard structures in high moisture environments. In some cases, moisture penetration cannot be avoided, resulting in a paperboard structure with very high moisture content. This disclosure relates to a strength preservation mechanism that enables high strength performance at very high moisture content.

Another aspect of this disclosure is related to improving the adhesion process during the production of the paperboard structures when making smooth, highly sized and/or high strength paperboards. In some cases, paperboard structures containing smooth, highly sized and/or high strength paperboards are difficult to laminate. The standard adhesive formulations cannot achieve a strong linkage to the paperboard surface due to smoothness, density or chemical composition of the board. This disclosure relates to formulations to enhance the lamination process, accelerating the adhesion of the substrates and/or increasing the strength of the bonded joint.

### Description of the Related Art

Tubes and cones (hereinafter collectively referred to as “tubes” or “carriers”) made of spirally or convolutely wound paper often are used to hold wound sheet materials such as carpet or strand materials such as yarn. The carriers may be custom made to satisfy a customer's needs, and can vary greatly due to paper stock, special finishing processes, chemical treatments, and the adhesives used to adhere the plies. The degree of crush, beam and torque strengths can be controlled to customer specifications. Carriers can be made to resist moisture, oil, chemicals, heat and abrasion.

Carriers used for carrying yarn and other strand materials typically have a smooth surface. However, they can be embossed, scored, grooved, perforated, polished, flocked, waxed and ground to provide desired surface characteristics. Tubes can be made with special inside or outside plies and can be made plain, colored or printed with stripes and other designs for identification purposes. Alternatively, colored bands can be applied to one or both ends. Labels applied to the inside of the tube can be used for further identification. Tube ends can be cut, crimped, rounded, beveled or otherwise finished to the customer's order.

Spirally wound tubes are particularly useful for carrying textiles, including yarn and thread. The tube can be made of plain paper stock and, for the outermost ply, a colored paper stock or a paper stock with a pattern or design. The ends typically are rounded.

The strength and dimensions of paperboard tubes and other paperboard structures is greatly affected by the moisture content of the structure. With increased moisture content, the strength of the structure is reduced and paper fibers swell, increasing the dimensions of the structure. With reduced moisture content, the strength of the structure increases and the paper fibers shrink, decreasing dimensions.

Maintaining an optimum amount of moisture in the structure can be critical for performance at the conditions of use. Deviations from this optimum moisture content can cause undesired deviations of the structure, affecting performance.

A wide range of options is known for controlling the moisture content of multiple-ply, wound paperboard tubes, including the use of moisture barrier plies, coatings and moisture barrier adhesives. Each of these options can reduce the penetration of moisture into the tube. Unfortunately, these options also keep the moisture inside the tube after production. Removing the moisture in the tube requires drying of the tube either by forced transport (drying) or by passive transport (conditioning), which requires additional cost and time.

Thus, a need exists for a moisture control mechanism that allows the moisture to leave the tube until the moisture level reaches a predetermined value or a predetermined range. Once this threshold level is achieved, the moisture barrier becomes active and limits moisture penetration into and out of the paperboard structure.

A need may also exist for a strength preservation mechanism for environments where moisture penetration cannot be delayed or avoided.

A preferred moisture control mechanism will allow a desired amount of moisture to evaporate out of the structure after tube manufacture/production, but then will maintain the desired moisture level by preventing ambient moisture from entering the tube and internal moisture from leaving the tube. A paperboard tube with such a differential, tailored moisture transport will outperform current tubes in applications where precise tube dimensions and strength preservation are valued. The preferred moisture control mechanism will also allow tube manufacturers to optimize their tube designs to take advantage of moisture control by eliminating the extra strength required to compensate for high moisture absorption of the tube while in use.

The present disclosure is designed to address the issues described above.

### BRIEF SUMMARY OF THE INVENTION

The present disclosure relates to a moisture control mechanism that will allow a desired amount of moisture to evaporate out of the structure after tube manufacture/production, but then will maintain the desired moisture level by preventing ambient moisture from entering the tube.

In one aspect, the disclosure relates to an improved core for winding sheet or strand materials, the core having a low moisture level. The core comprises a hollow cylindrical body comprising multiple plies, and a moisture control mechanism that allows moisture to leave the core, then, when the moisture level reaches a predetermined value, activates a moisture barrier to limit or prevent moisture from entering the core, thereby maintaining the moisture content of the core at or below the predetermined value. The moisture control mechanism may comprise an adhesive that adheres the multiple plies together, the adhesive comprising dextrin and an acrylic polymer. The acrylic polymer may be selected from the group consisting of methylmethacrylate (MMA), sodium polyacrylate, polyvinyl acetate (PVA) and polyacrylamide (PAA). Alternatively, the acrylic polymer comprises one or more of methylmethacrylate (MMA), sodium polyacrylate, polyvinyl acetate (PVA) and polyacrylamide (PAA). The adhesive may comprise at least 20 wt % acrylic polymer, and more specifically, 20-60 wt % acrylic polymer.

In one aspect, the disclosure relates to an improved core for winding sheet or strand materials, the core maintaining strength even at a high moisture level. The core comprises a hollow cylindrical body comprising multiple plies, and a strength preservation mechanism that allows the core to retain most of its strength, even when operating at high moisture content levels. The strength preservation mechanism may comprise an adhesive that adheres the multiple plies together, the adhesive comprising dextrin and an acrylic polymer. The acrylic polymer may be selected from the group consisting of methylmethacrylate (MMA), sodium polyacrylate, polyvinyl acetate (PVA) and polyacrylamide (PAA). Alternatively, the acrylic polymer comprises one or more of methylmethacrylate (MMA), sodium polyacrylate, polyvinyl acetate (PVA) and polyacrylamide (PAA). The adhesive may comprise at least 20 wt % acrylic polymer, and more specifically, 20-60 wt % acrylic polymer.

In another aspect, a method of making a multiple ply structure comprising multiple sheets of paperboard is provided. The method may comprise the steps of providing an adhesive composition comprising dextrin and an acrylic polymer, and applying the adhesive composition as an adhesive agent or a laminating agent to one of two surfaces of at least one of the sheets, wherein the adhesive composition bonds the two surfaces together to form the multiple ply structure.

In still another aspect the disclosure relates to an adhesive composition for use in making a paperboard structure comprising multiple plies. The adhesive composition may comprise 40-80 wt % dextrin, and 20-60 wt % acrylic polymer, wherein the adhesive composition allows moisture to leave the paperboard structure, then, when the moisture level reaches a predetermined value, activates a moisture barrier to limit or prevent moisture from entering the paperboard structure, thereby maintaining the moisture content of the paperboard structure at or below the predetermined value.

### BRIEF DESCRIPTION OF THE DRAWINGS

FIG. 1 is a perspective view of a tube carrying wound strand material;

FIG. 2 is a schematic depiction of a tube such as that of FIG. 1 being formed and cut;

FIG. 3 is a graph showing the force required to deflect (displace) certain high moisture paperboard tubes, including control tubes and tubes made according to the present disclosure; and

FIG. 4 is a tack test graph comparing tack test for adhesive blends in accordance with the present disclosure and a dextrin control adhesive.

### DETAILED DESCRIPTION OF THE INVENTION

While the invention described herein may be embodied in many forms, there is shown in the drawings and will herein be described in detail one or more embodiments with the understanding that this disclosure is to be considered an exemplification of the principles of the invention and is not intended to limit the disclosure to the illustrated embodiments. Aspects of the different embodiments can be combined with or substituted for one another.

The discussion below relates mainly to tubes of the kind that carry strand or sheet material. It should be understood that the disclosure also relates to other paperboard structures comprising an adhesive that adheres multiple plies together.

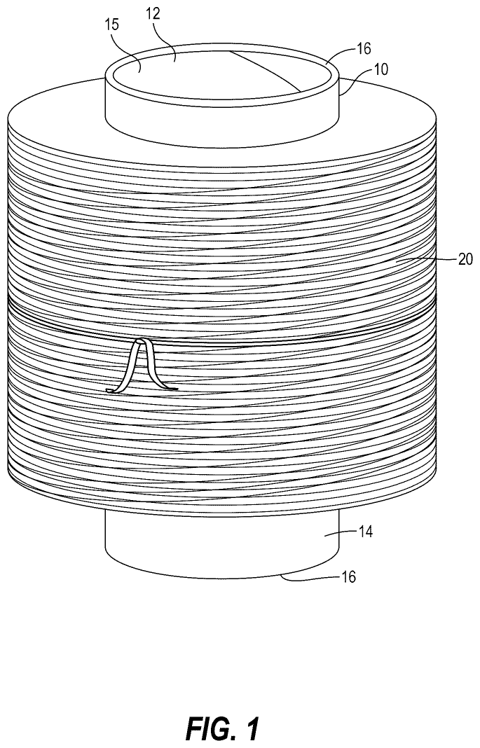

Turning to the drawings, where like numerals indicate like elements, there is shown in FIG. 1 a perspective view of a tube carrying wound strand material. The tube 10 may comprise a hollow cylindrical body 12 having an outer surface 14, an inner surface 15 and opposing ends 16. The tube 10 has an axial dimension extending from one end 16 to the other end 16 and a radial dimension extending radially outward.

The carrier 10 may be used to carry strand material 20 such as yarn, or sheet material such as fabric, foil or paper. Typical tubes 10 for carrying textiles may have an outer diameter of three to four inches (7.62 to 10.16 cm) and may be about one foot (30.48 cm) in axial length, although the tubes 10 may be any suitable dimensions depending on the application.

The carrier 10 may comprise a tubular shape as illustrated in FIG. 1. In alternate embodiments the carrier 10 instead can take the form of a conical shape or other shapes depending on the specific application. The carrier 10 in FIG. 1 is illustrated as a spirally wound carrier 10 in which strips of material are helically wrapped, but carriers in accordance with the invention can instead be convolutedly wrapped. If the carrier 10 is to be used to carry a textile, the carrier 10 may be sold to the textile manufacturer who then winds their product 20 on the carrier 10.

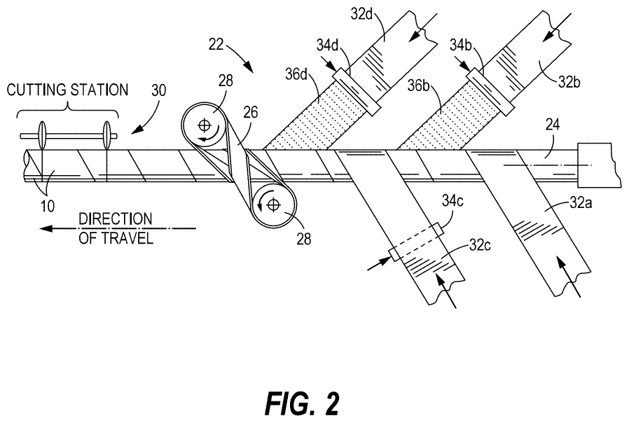

FIG. 2 is a schematic depiction of a tube 10 such as the tube 10 of FIG. 1 being formed and cut. The illustrated winding apparatus 22 is a spiral winding apparatus for making spirally or helically wound tubes 10. This particular winding apparatus 22 is used to manufacture a 4-ply tube, but the principles pertaining to the 4-ply tube are equally applicable to tubes having any number of plies. The winding apparatus 22 includes a cylindrical mandrel 24 whose diameter is selected to match the desired inside diameter of the tubes 10 to be manufactured, a winding belt 26 arranged to wrap about the tube formed on the mandrel 24 and about a pair of rotating drums 28 that drive the belt 26 such that the belt 26 advances the tube along the mandrel 24 in screw fashion at a substantially constant pitch.

Four paperboard strips 32a, 32b, 32c, and 32d are drawn from respective supply rolls (not shown), are advanced toward the mandrel 24 and are sequentially wrapped about the mandrel 24 in radially superposed fashion, one atop another. The winding apparatus 22 may include adhesive applicators 34b, 34c, and 34d for applying adhesive to each of strips 32b, 32c, and 32d, respectively, such as in the partial-coverage patterns 36b and 36d shown in FIG. 2.

After the spiral winding operation, the resulting elongate structure is cut to create a tube 10 having opposing first and second ends 16 and a desired axial length. Referring again to FIG. 2, a cutting station 30 downstream of the winding apparatus may be used to cut the continuous tube formed on the mandrel 24 into individual tubes 10.

As noted above, adhesive applicators 34b, 34c, and 34d may be used to apply adhesive to each of the strips 32b, 32c, and 32d. In many embodiments, the adhesive may comprise an aqueous adhesive. Very commonly, the adhesive is a starch-based adhesive, such as dextrin. Dextrin based adhesives are broadly used in paperboard laminated structures due to their flexibility and low cost. However, one shortcoming of dextrin adhesives is their tendency to absorb moisture when exposed to a high humidity environment. As a result, the strength of the bonded joint can decrease with increasing moisture content. The reduced joint strength is reflected in a lower compression strength of the paperboard structure.

In some applications, a polymeric adhesive is used instead of the dextrin adhesive to impart moisture absorption resistance to the paperboard structure. In other applications, a special outer ply is laminated into the structure to keep moisture from penetrating the article. The special ply or plies are made from a barrier material such as a polymer or metal sheet. These plies can reduce the penetration of moisture and allow preservation of the compressive strength by keeping the dextrin joints between plies from absorbing moisture. However, the cost and complexity of the lamination process increases when polymeric adhesives or specialty plies are used in the manufacturing process.

The standard practice in the art is to use either dextrin adhesive or a polymeric adhesive, but not both, when making the laminated structure. Due to their chemical properties, a combination of these two formulations can result in a reaction that will cause the rapid degradation of the combined formulation. Combining starch based and polymeric adhesives will normally result in an immediate failure of the combined adhesive, ending in a catastrophic failure.

In the search for strength preservation of laminated paperboard structures exposed to high moisture environments, the inventors investigated the use of modified polymeric adhesives, searching for a suitable polymeric adhesive formulation that can be combined with dextrin based adhesives. After much experimentation, it was found that a modified acrylic adhesive could be blended with a dextrin adhesive without having the expected adhesive degradation failures. The novel combinations of a modified acrylic adhesive and a dextrin adhesive formulation did not degrade, and also achieved strength preservation of the tube.

This surprising and unexpected result was observed in tests conducted with tubes produced with a standard dextrin adhesive and tubes produced with an adhesive formulation comprising a dextrin plus an acrylic polymer. The tubes produced with a standard dextrin adhesive and exposed to a high moisture environment for a prolonged time period could be squeezed and compressed by hand. By contrast, the tubes produced with the dextrin plus acrylic polymer formulation could not be compressed by hand. Considering that all the tubes ended up with a high moisture content, this was quite unique. Expanding on these unexpected results, the inventors explored the impact of different adhesive blend ratios and found that by adjusting the blend ratios, different performance and cost profiles could be achieved.

The acrylic polymer adhesive component may be a resin-based adhesive comprised of acrylic or methylacrylic polymers, such as methylmethacrylate (MMA), sodium polyacrylate, polyvinyl acetate (PVA, commonly known as “white glue”) and polyacrylamide (PAA).

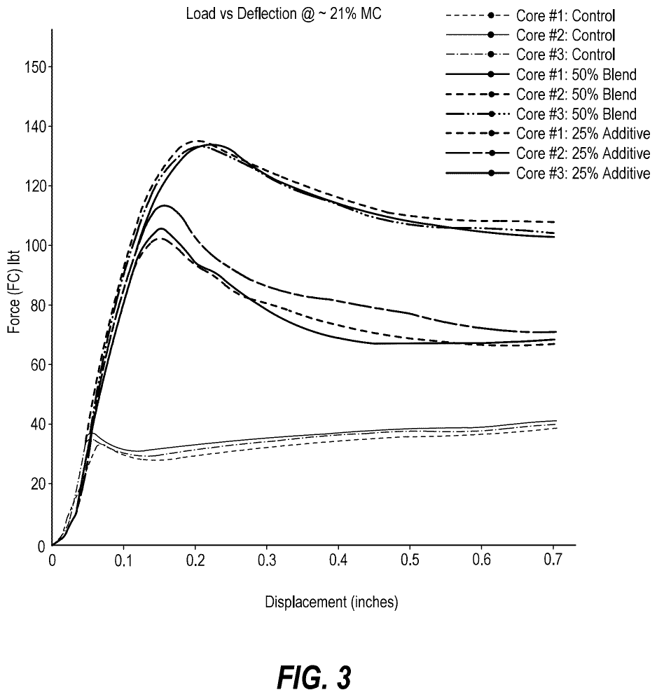

FIG. 3 is a graph showing the force required to deflect (displace) certain paperboard tubes, including control tubes and tubes made according to the present disclosure. As shown in the graph, at 21% by weight moisture in the tubes, the three tubes made with an adhesive comprising a blend of 50 wt % dextrin and 50 wt % polymer adhesive tested best, followed by the three tubes made with an adhesive comprising a blend of 75 wt % dextrin and 25 wt % polymer adhesive. The three tubes made with a dextrin only adhesive (the “control” group) exhibited the lowest strength. In summary, FIG. 3 demonstrates that, for high moisture content tubes, tubes produced with a dextrin plus acrylic polymer formulation exhibited better strength than tubes produced with a dextrin only adhesive.

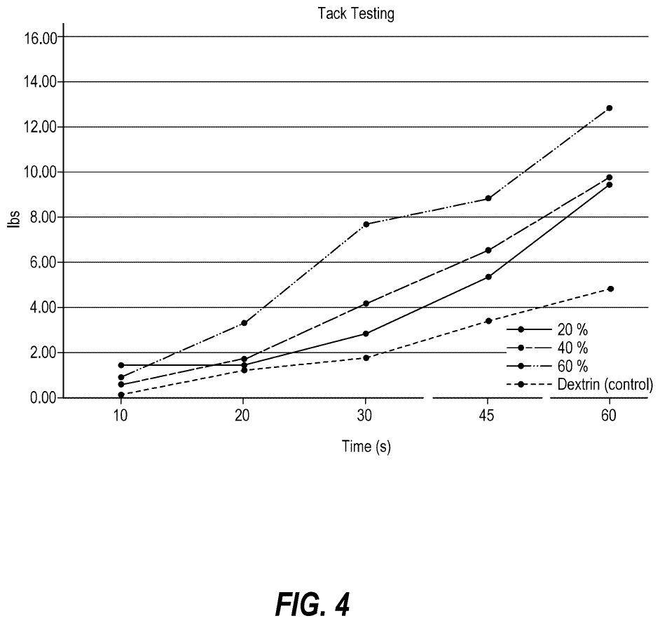

FIG. 4 is a tack test graph. Tack is the property of an adhesive that allows it to adhere to a substrate. Thought of another way, tack is the “stickiness” of an adhesive while in a fluid (e.g., paper cement) or semi-fluid (e.g., pressure sensitive adhesive) state. According to one ASTM standard, tack is the property that enables an adhesive to form a bond of measurable strength with the surface of a material after being in contact and under high pressure for a specific (short) period of time. Generally, a higher tack adhesive is desirable when used to form multiple-ply tubes and cores.

The graph in FIG. 4 shows tack performance for three different dextrin/polymer adhesive blends and a dextrin control adhesive. More specifically, the graph shows the amount of force (in pounds) needed to overcome the adhesiveness (tack) of the three different dextrin/polymer adhesive blends and the dextrin control adhesive.

The tack tests were performed as follows. Adhesive was applied to the surface of a smooth block. A strip of paper was then set onto the adhesive coated block and a reproducible pressure was applied to the paper for a period of time varying from 10 seconds to 60 seconds. Finally, the force required to peel the paper from the block was measured.

In FIG. 4, the adhesive comprising 60 wt % acrylic polymer demonstrated the highest tack for all samples after pressure was applied for 20, 30, 45 and 60 seconds. The adhesive comprising 40 wt % acrylic polymer demonstrated the next highest tack for all samples after pressure was applied for 20, 30, 45 and 60 seconds, followed by the adhesive comprising 20 wt % acrylic polymer. The dextrin control adhesive demonstrated the least amount of tack.

In summary, all three polymer blend adhesives outperformed the dextrin control adhesive in terms of level of tack. The highest tack in terms of force required to overcome the stickiness of the adhesive was obtained with a 60 wt % acrylic polymer blend. Thus, it may be said that adhesive blends of 60 wt %, 40 wt % and 20 wt % acrylic polymer each created stronger bonds than dextrin adhesive alone.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A core for winding sheet or strand materials, the core having a moisture level, the core comprising:
a hollow cylindrical body comprising multiple plies; and
a moisture control mechanism that allows moisture to leave the core, then, when the moisture level reaches a predetermined value, activates a moisture barrier to limit or prevent moisture from entering the core, thereby maintaining the moisture content of the core at or below the predetermined value.

2. The core of claim 1 wherein:
the moisture control mechanism comprises an adhesive that adheres the multiple plies together, the adhesive comprises dextrin and an acrylic polymer.

3. The core of claim 2 wherein:
the acrylic polymer is selected from the group consisting of methylmethacrylate (MMA), sodium polyacrylate, polyvinyl acetate (PVA) and polyacrylamide (PAA).

4. The core of claim 2 wherein:
the acrylic polymer comprises one or more of methylmethacrylate (MMA), sodium polyacrylate, polyvinyl acetate (PVA) and polyacrylamide (PAA).

5. The core of claim 4 wherein:
the adhesive comprises 20-60 wt % acrylic polymer.

6. The core of claim 4 wherein:
the adhesive comprises 60 wt % acrylic polymer.

7. The core of claim 4 wherein:
the adhesive comprises at least 20 wt % acrylic polymer.

8. The core of claim 1, wherein the strength preservation mechanism allows the core to maintain a high strength level at approximately 21% moisture content.

9. A method of making a multiple ply structure comprising multiple sheets of paperboard, the method comprising the steps of:
providing an adhesive composition comprising dextrin and an acrylic polymer; and
applying the adhesive composition as an adhesive agent or a laminating agent to one of two surfaces of at least one of the sheets, wherein the adhesive composition bonds the two surfaces together to form the multiple ply structure.

10. The method of claim 9 wherein:
the acrylic polymer comprises one or more of methylmethacrylate (MMA), sodium polyacrylate, polyvinyl acetate (PVA) and polyacrylamide (PAA).

11. The method of claim 10 wherein:
the adhesive comprises 20-60 wt % acrylic polymer.

12. The method of claim 10 wherein:
the adhesive comprises 60 wt % acrylic polymer.

13. The method of claim 10 wherein:
the adhesive comprises at least 20 wt % acrylic polymer.

14. An adhesive composition for use in making a paperboard structure comprising multiple plies, the adhesive composition comprising:
40-80 wt % dextrin; and
20-60 wt % acrylic polymer, wherein the adhesive composition allows moisture to leave the paperboard structure, then, when the moisture level reaches a predetermined value, activates a moisture barrier to limit or prevent moisture from entering the paperboard structure, thereby maintaining the moisture content of the paperboard structure at or below the predetermined value.

15. The adhesive composition of claim 14 wherein:
the acrylic polymer is selected from the group consisting of methylmethacrylate (MMA), sodium polyacrylate, polyvinyl acetate (PVA) and polyacrylamide (PAA).

16. The adhesive composition of claim 14 wherein:
the acrylic polymer comprises one or more of methylmethacrylate (MMA), sodium polyacrylate, polyvinyl acetate (PVA) and polyacrylamide (PAA).

17. The adhesive composition of claim 14 wherein:
the adhesive composition comprises 60 wt % acrylic polymer.

18. The adhesive composition of claim 14 wherein:
the adhesive composition comprises at least 20 wt % acrylic polymer.

19. The adhesive composition of claim 14, wherein the adhesive composition allows a strength preservation mechanism that allows the core to maintain a high strength level at approximately 21% moisture content.
